(19) United States
(12) Patent Application Publication
(10) Pub. No.: US 2019/0205483 A1
(43) Pub. Date: Jul. 4, 2019

(54) DATA PROCESSING IN ADDITIVE MANUFACTURING

(71) Applicant: HEWLETT-PACKARD DEVELOPMENT COMPANY, L.P., Houston, TX (US)

(72) Inventors: Alejandro Manuel De Pena, Sant Cugat del Valles (ES); Josep Giralt Adroher, Sant Cugat del Valles (ES); Sebastia Cortes I Hermes, Sant Cugat del Valles (ES)

(73) Assignee: HEWLETT-PACKARD DEVELOPMENT COMPANY, L.P., Houston, TX (US)

(21) Appl. No.: 16/093,058

(22) PCT Filed: May 12, 2016
(86) PCT No.: PCT/EP2016/060708

§ 371 Date: Oct. 11, 2018

(51) Int. Cl. G06F 17/50; B29C 64/393

(52) U.S. Cl. CPC G06F 17/50; B33Y 50/02; B29C 64/393

(57) ABSTRACT

In an example, a method comprises receiving machine-readable data relating to a three-dimensional object to be generated by an additive manufacturing apparatus, the machine-readable data being in a first data format. The method may further include processing, by a processor, the machine-readable data. The processing may comprise converting, by a processor, the machine-readable data from the first data format into a second data format suitable for use by the additive manufacturing apparatus to generate the three-dimensional object; and extracting metadata from the machine-readable data. The method may further include providing the processed data to an additive manufacturing apparatus for use in generating the three-dimensional object.

### BACKGROUND

Additive manufacturing techniques may generate a three-dimensional object on a layer-by-layer basis through the solidification of a build material. In examples of such techniques, build material is supplied in a layer-wise manner and a solidification method may include heating the layers of build material to cause melting in selected regions. In other techniques, other solidification methods, such as chemical solidification methods or binding materials, may be used.

Data relating to a three-dimensional object to be generated may be provided to an additive manufacturing apparatus and used to generate the three-dimensional object.

### BRIEF DESCRIPTION OF DRAWINGS

Examples will now be described, by way of non-limiting example, with reference to the accompanying drawings, in which:

FIG. 1 is a flowchart of an example method for processing data;

FIG. 2 is a schematic of an example voxelisation process;

FIG. 3 is a flowchart of an example of a method of processing data in an additive manufacturing process;

FIG. 4 is a simplified schematic of an example machine-readable medium with a processor to perform a method of processing data in an additive manufacturing process;

FIG. 5 is a simplified schematic of an example of apparatus to process data in an additive manufacturing process; and

FIG. 6 is a simplified schematic of an example of apparatus to process data in an additive manufacturing process.

### DETAILED DESCRIPTION

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern. In other examples, coalescence may be achieved in some other manner.

In addition to a fusing agent, in some examples, a print agent may comprise a coalescence modifying agent (referred to as modifying or detailing agents herein after), which acts to modify the effects of a fusing agent for example by reducing or increasing coalescence or to assist in producing a particular finish or appearance to an object, and such agents may therefore be termed detailing agents. A coloring agent, for example comprising a dye or colorant, may in some examples be used as a fusing agent or a modifying agent, and/or as a print agent to provide a particular color for at least a portion of the object.

Additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

An example additive manufacturing process may involve various processes. A layer of build material may be formed onto a print bed, or build platform. The layer of build material may be formed using, for example, a build material distributor, which may deposit and spread build material onto the print bed at an intended thickness. The layer of build material may be preheated using, for example, a radiation source such as an infrared lamp, or by some other means. Print agent may be distributed onto the layer of build material by an agent distributor. Energy, for example heat from a fusing lamp or from multiple fusing lamps, may be applied to the layer of build material so as to cause coalescence and solidification of those portions of build material to which fusing agent has been applied. In a further example, the layer of build material may be allowed to settle and cool down.

The processes described above with reference to an example additive manufacturing process may form part of a layer processing cycle which may be repeated for each layer of a multi-layered object to be generated. The layer processing cycle, or layer generation cycle, may be considered to include a set of processes performed in respect of a single layer of build material so as to form a slice of the three-dimensional object to be built, and the time to perform the set of processes in respect of a single layer of build material may be considered to be a layer processing time, or layer generation time.

It is intended that the layer processing time, in some examples, may be the same or approximately the same for all of the layers of an object to be generated. That is to say, the layer processing time for each layer in an additive manufacturing process may be approximately constant or fixed. Here, the expression “the same” is intended to mean exactly the same or approximately the same. Maintaining a constant or approximately constant layer processing time for all layers of an object to be generated helps to ensure that the object is generated with consistent layers.

As noted above, an additive manufacturing apparatus may generate a three-dimensional object on a layer-by-layer basis, based on data received, for example from a designer. The data may, in some examples, be in a format which accurately describes the three-dimensional object to be generated, for example as a mesh formed of a plurality of polygons, but this format may not be compatible with the additive manufacturing apparatus. In other examples, the received data may include a large amount of detail about some portions of the object to be generated, for example, portions at a surface of the object. Data relating to the portions at a surface of an object may, for example, include details of intricate shapes of the surface of the object and/or details of colors to be used at the surface. The amount of data relating to such portions may, therefore, by relatively large. Other portions of the object may include relatively little detail and, accordingly, the amount of data relating to those portions may be relatively small. The time to process the data for a particular layer or portion may, therefore, depend on the amount of data relating to that particular layer or portion. To maintain a constant layer processing time for all layers of the object, some of the data processing may, in some examples, be performed before the generation of the object begins.

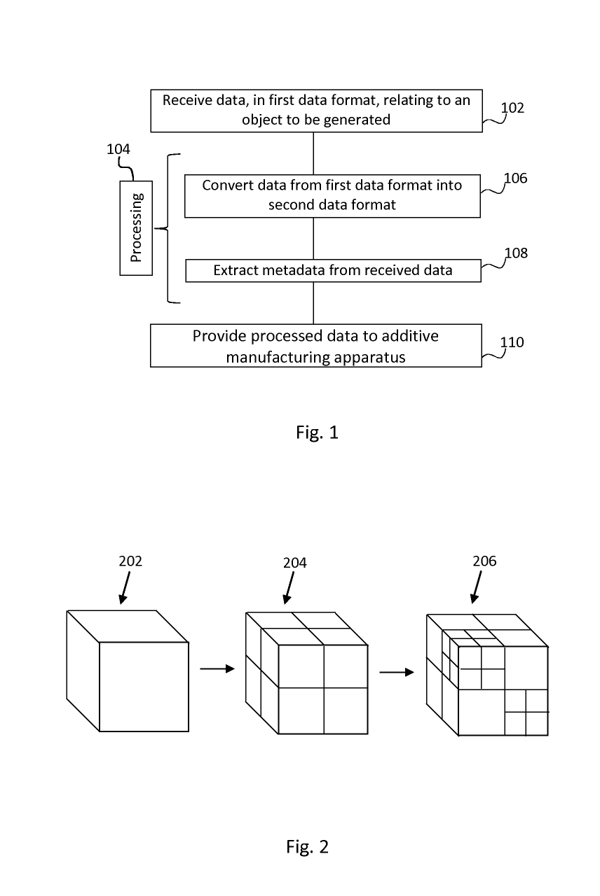

FIG. 1 is a flowchart of an example method for processing data. The method comprises, at block 102, receiving machine-readable data relating to a three-dimensional object to be generated by an additive manufacturing apparatus, the machine-readable data being in a first data format. The data may be received, for example, by processing apparatus, such as a processor, which may form part of a computing system or server, and which may be part of, connected to, or remote from, the additive manufacturing apparatus.

In some examples, the first data format may be selected from a group consisting of: EXtensible Markup Language (XML), STereoLithography (STL), Virtual Reality Modeling Language (VRML), object (OBJ), Additive Manufacturing File Format (AMF), and 3D Manufacturing Format (3MF). In general, the received data may be in any data format suitable for describing a three-dimensional object. In some examples, the object or a portion of the object may be described in terms of a mesh in the first data format.

The method further comprises, in block 104, processing the machine-readable data using a processor. The processing comprises, in block 106, converting, using a processor, the machine-readable data from the first data format into a second data format suitable for use by the additive manufacturing apparatus to generate the three-dimensional object. The processing also comprises, in block 108, extracting metadata from the machine-readable data. The data conversion and the metadata extraction will be discussed in greater detail below.

In block 110, the method comprises providing the processed data to an additive manufacturing apparatus for use in generating the three-dimensional object.

The data processing of block 104 may be done before the additive manufacturing apparatus begins to generate the object. In this way, the data conversion and the extraction of metadata need not be performed by the additive manufacturing apparatus while the layers of the object are being generated, in real time. In other words, by pre-processing the data, less data processing is to be done during each layer generation cycle.

As noted above, in the first data format, the data may include large amounts of detail relating to a particular layer or portion of the object to be generated. Data in the first data format can be considered to be ‘unbounded’, and data in the second data format can be considered to be ‘bounded’. The term ‘bounded’ is intended to describe data that has defined boundaries. Bounded data can be processed (in an additive manufacturing process) in a predictable way and, therefore, within a predictable time frame. In contrast, unbounded data may not be considered to have defined boundaries, and may not be processed (in an additive manufacturing process) in a predictable way. Thus, by converting the data into data with bounded process complexity (for example, into the second data format), the time to process the data during the additive manufacturing process can be predicted and controlled, and the layer processing time for each layer can be kept constant.

The data conversion may, in some examples, include converting the machine-readable data from the first data format to an intermediate data format; and converting the machine-readable data from the intermediate data format to the second data format. By converting the data into an intermediate data format, the processing burden may be reduced. The intermediate data format may be optimised to reduce the conversion time from the intermediate data format into the second format. For example, the intermediate data format may be optimised to reduce the time to perform a “voxelisation” process on the data, as is discussed below.

In some examples, the metadata extracted from the data may include at least one type of metadata selected from a group consisting of: (i) an indication of a position of a portion of the three-dimensional object to be generated relative to a boundary of the three-dimensional object; (ii) a distance of a portion of the three-dimensional object to be generated from a boundary of the three-dimensional object; (iii) an indication of a volumetric density of a portion of the three-dimensional object to be generated; and (iv) a color of a portion of the three-dimensional object to be generated. By extracting metadata from the object data before the additive manufacturing process begins, the amount of real-time data processing to be done by the additive manufacturing apparatus can be reduced. For example, by extracting metadata relating to a position of a portion of the object relative to, or a boundary of the object, or a distance of a portion of the object from a boundary, it may be possible to determine, prior to the start of the manufacturing process, whether fusing agent and/or detailing agent is to be distributed onto a particular portion of a layer of build material. Similarly, by extracting metadata relating to a volumetric density of a portion of the object, or a colour of a portion of the object, it may be possible to determine, prior to the start of the manufacturing process, an amount of fusing agent to be applied, or a type of detailing agent to be applied. By making such determinations prior to the start of the manufacturing process, less data processing may need to be performed by the apparatus during the manufacturing process and, therefore, the layer generation times may be reduced.

In some examples, the method may further comprise using the converted data and the metadata to process successive layers of build material to form successive layers of the three-dimensional object, the processing of the each layer being performed within a predetermined layer processing time. As discussed above, the pre-processing of the data may help the additive manufacturing apparatus to perform the processing of each layer within the predetermined layer processing time.

In some examples of the method, the conversion of machine-readable data may comprise generating, using a processor, a voxel representation of the object to be generated, as is discussed below. The generating may, in some examples of the method, comprise determining, using a processor, for a particular voxel in the representation, whether the particular voxel represents a portion of a boundary of the object. In response to a determination that the particular voxel represents a portion of a boundary of the object, subdividing said particular voxel into eight smaller voxels. Each of the smaller voxels may, in some examples, be an octant of the particular voxel.

FIG. 2 shows, schematically, three stages of an example voxelisation process which, in some examples, may form part of the data conversion process discussed herein. In the format in which the data is received, the object may be represented in the form of a mesh, or a model. The object may be represented by a plurality of voxels, for example by generating a three-dimensional grid, such as a Cartesian grid, over the model of the object. Each unit of the grid represents a voxel, such as the voxel shown at a first stage 202 in FIG. 2. The data conversion, in some examples, may involve processing each voxel by determining whether a particular voxel in the grid: (i) corresponds to a region outside the boundary of the object (that is to say, no part of the object falls within the voxel); (ii) corresponds to a region within the boundary of the object (that is to say, the entire volume of the voxel contains part of the object); or (iii) corresponds to a region at the boundary of the object (that is to say, part of the voxel falls outside the object boundary and part of the voxel falls within the object boundary).

If a particular voxel is determined to fall entirely outside the object boundary as in (i) above, or entirely within the object boundary as in (ii) above, then this information may be provided to the additive manufacturing apparatus. Thus, when a corresponding portion of the object is to be generated, the apparatus knows from the provided information that, for that particular voxel, no fusing agent is to be applied in case (i), or using agent is to be applied in case (ii).

If a particular voxel is determined to correspond to a region at the object boundary, then the voxel may be subdivided into eight octants, as shown in a second stage 204 in FIG. 2. The subdivision of the data may be performed, in some examples, by representing the object data in an octree data structure, whereby each voxel is represented by a node. Each octant of a voxel that has been subdivided may be represented by one of eight child nodes. Each of the octants of the voxel at the second stage 204 may be processed in a similar manner, which each octant representing a smaller voxel.

If a determination is made that any of the smaller voxels in the voxel at the second stage 204 correspond to a region at the boundary of the object, then those smaller voxels may themselves may each be subdivided into eight octants as shown, for example in voxel shown at a third stage 206 of FIG. 2. By subdividing the voxels corresponding to a region at a boundary of the object, the resolution of the voxelised representation of the object is effectively increased at the boundary regions. The number of iterations of subdividing voxels may be based on the resolution of the print agent distributor of the additive manufacturing apparatus. For example, in some examples, two subdivisions of the voxels may provide a suitable resolution.

In its voxelised form, the data may represent the object to be printed in terms of a finite number of voxels, or discrete volumes, for which the real time processing time may be accurately determined.

In some examples, the metadata extracted from the machine-readable data may comprise metadata relating to a position of a voxel in the voxel representation relative to a boundary of the object to be generated. Such metadata may, in some examples, include information of a distance of the voxel from an edge of the print bed of the additive manufacturing apparatus, and/or of a distance of the voxel above the print bed.

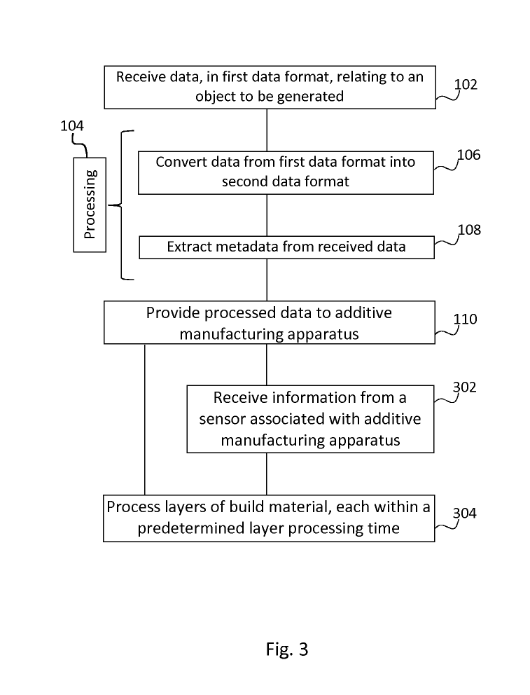

A flowchart of an example of a method of processing data for an additive manufacturing process is shown in FIG. 3. The flowchart of FIG. 3 includes the blocks 102 to 110 shown in FIG. 1 and, additionally, blocks 302 and 304. The method may comprise, at block 302, receiving information from a sensor associated with the additive manufacturing apparatus. The received information may then be used by the additive manufacturing apparatus in block 304 to process the layers of build material to form successive layers of the three-dimensional object, the processing of the each layer being performed within a predetermined layer processing time. In some examples, the processing of block 304 may be done based on the processed data provided in block 110, without receiving data at block 302.

In some examples, the method may, following receipt of information at block 302, comprise modifying, by a processor, the processed data based at least in part on the received information. In this way, the processed data may be considered to be modified or updated during the manufacturing process in real time in response to data received in real time from the sensor. For example, the amount of print agent and the locations of where the print agent, including fusing agent and detailing agent, is to be distributed may be dynamically modified in real time during the manufacturing process. Since the data relating to the object to be generated may be pre-processed before the start of the manufacturing process, the real time processing burden when updating or modifying the processed data may be reduced, and the predetermined layer processing time for each layer is not affected.

In some examples, the sensor may comprise a thermal sensor, such as thermal imaging camera, to obtain thermal data relating to a portion of the additive manufacturing apparatus and/or a portion of the object being generated. In one example, a thermal imaging camera may receive thermal data relating to the print bed and/or a portion of build material formed on the print bed. Such thermal data may, for example, include an indication of a temperature of a portion of the print bed and/or a temperature of a portion of the build material in each layer. The data acquired by the thermal imaging camera, and by any other sensors, may be provided to a processor of the additive manufacturing apparatus, which may use the data to determine whether or not any action is to be taken. For example, if a determination is made that a temperature of a portion of a layer of build material is above a predetermined threshold, then the processor may, for example, arrange for less print agent to be delivered to a corresponding portion on the subsequent layer of build material in order to prevent the temperature of the previous layer from increasing beyond an upper threshold temperature. If the temperature of a portion of build material increases beyond an upper threshold temperature, or if the temperature remains above a predetermined temperature for too long, then portions of build material to which fusing agent has not been applied may be caused to fuse as a result of the high temperature. Thus, data from sensors, such as the thermal imaging camera, enable the processor to regulate parameters during the layer generation and to control components of the additive manufacturing apparatus in response to data received from the sensors.

The processes discussed herein with reference to blocks in FIGS. 1 and 3 may, in some examples, each be performed by a separate processor or processing apparatus. In other examples, the processes may be performed by a single processor or processing apparatus, or may be shared among a plurality of processors.

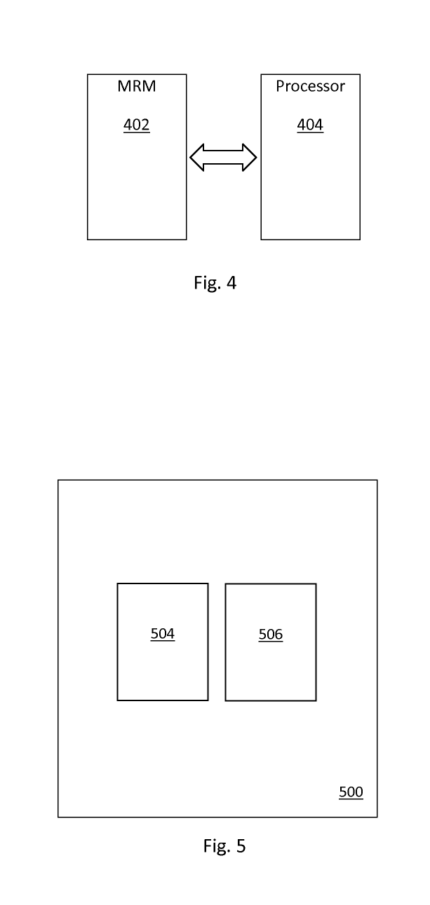

FIG. 4 shows a machine-readable medium 402 associated with a processor 404. The machine-readable medium 402 comprises instructions which, when executed by the processor 404, cause the processor 404 to transform machine-readable data from a first data format into a second data format, the machine-readable data relating to an object to be generated by an additive manufacturing apparatus, the data in the second data format being suitable for use by the additive manufacturing apparatus to generate the object, and analyse said machine-readable data to determine a property of a portion of the object to be generated.

In some examples, the machine-readable medium 402 may further comprise instructions which, when executed by the processor 404, cause the processor 404 to structure the machine-readable data into an octree data structure including a plurality of nodes.

The machine-readable medium 402 may further comprise instructions which, when executed by the processor 404, cause the processor 404 to instruct an additive manufacturing apparatus to generate a portion of the object based at least in part on the transformed data and the determined property.

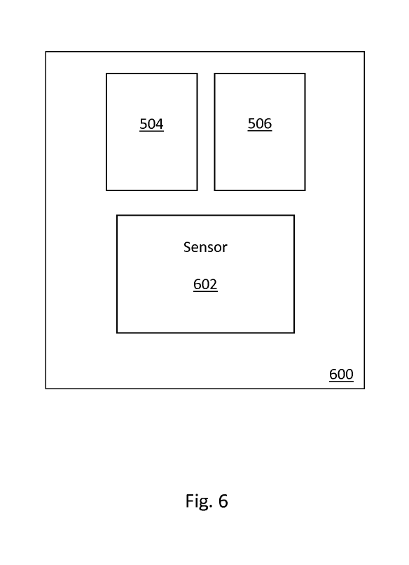

FIGS. 5 and 6 are simplified schematics of an example apparatus 500 for processing data. FIG. 5 shows an apparatus 500 which comprises a data format modification module 504 to modify a format of data from a first data format into a second data format, the data relating to a three-dimensional object to be generated by an additive manufacturing apparatus, the second data format being suitable for use by the additive manufacturing apparatus to generate the three-dimensional object. The apparatus 500 also comprises a retrieval module 506 to retrieve metadata from the data, the metadata relating to a portion of the three-dimensional object. In a further example, the apparatus 500 may comprise data processing apparatus. In some examples, the data processing apparatus may comprise the data format modification module 504 and the retrieval module 506.

In some examples, the apparatus may comprise additive manufacturing apparatus. An example additive manufacturing apparatus 600 is shown in FIG. 6. The additive manufacturing apparatus 600 may comprise a sensor 602 to generate information relating to at least one of: the additive manufacturing apparatus and a portion of the three-dimensional object. In some examples, the sensor 602 may comprise a thermal imaging camera to receive thermal data relating to a print bed (not shown) and/or build material formed on the print bed. The additive manufacturing apparatus may further comprise the data format modification module 504 and the retrieval module 506.

Examples in the present disclosure can be provided as methods, systems or machine-readable instructions, such as any combination of software, hardware, firmware or the like. Such machine-readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine-readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus functional modules of the apparatus and devices may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving machine-readable data relating to a three-dimensional object to be generated by an additive manufacturing apparatus, the machine-readable data being in a first data format; and
processing, by a processor, the machine-readable data, said processing comprising:
converting, by a processor, the machine-readable data from the first data format into a second data format suitable for use by the additive manufacturing apparatus to generate the three-dimensional object; and
extracting metadata from the machine-readable data; and
providing the processed data to an additive manufacturing apparatus for use in generating the three-dimensional object.

2. The method of claim 1, further comprising:
using the converted data and the metadata to process successive layers of build material to form successive layers of the three-dimensional object, the processing of the each layer being performed within a predetermined layer processing time.

3. The method of claim 2, further comprising:
receiving information from a sensor associated with the additive manufacturing apparatus; and
using the received information to process the layers of build material.

4. The method of claim 2, further comprising:
receiving information from a sensor associated with the additive manufacturing apparatus; and
modifying, by a processor, the processed data based at least in part on the received information.

5. The method of claim 1, wherein said converting comprises:
converting the machine-readable data from the first data format to an intermediate data format; and
converting the machine-readable data from the intermediate data format to the second data format.

6. The method of claim 1, wherein said converting comprises:
generating, by a processor, a voxel representation of the object to be generated.

7. The method of claim 6, wherein said metadata comprises metadata relating to a position of a voxel in the voxel representation relative to a boundary of the object to be generated.

8. The method of claim 6, wherein said generating further comprises:
determining, by a processor, for a particular voxel in the representation, whether the particular voxel represents a portion of a boundary of the object; and
in response to a determination that the particular voxel represents a portion of a boundary of the object, subdividing said particular voxel into eight smaller voxels.

9. The method of claim 1, wherein the first data format comprises a data format selected from a group consisting of: EXtensible Markup Language, XML, STereoLithography, STL, Virtual Reality Modeling Language, VRML, object, OBJ, Additive Manufacturing File Format, AMF and 3D Manufacturing Format, 3MF.

10. The method of claim 1, wherein said metadata comprises at least one type of metadata selected from a group consisting of: (i) an indication of a position of a portion of the three-dimensional object to be generated relative to a boundary of the three-dimensional object; (ii) a distance of a portion of the three-dimensional object to be generated from the boundary of the three-dimensional object; (iii) an indication of a volumetric density of a portion of the three-dimensional object to be generated; and (iv) a color of a portion of the three-dimensional object to be generated.

11. A machine-readable medium comprising instructions which, when executed by a processor, cause the processor to:
transform machine-readable data from a first data format into a second data format, the machine-readable data relating to an object to be generated by an additive manufacturing apparatus, the data in the second data format being suitable for use by the additive manufacturing apparatus to generate the object; and
analyse the machine-readable data to determine a property of a portion of the object to be generated.

12. A machine-readable medium according to claim 11, further comprising instructions which, when executed by a processor, cause the processor to:
structure the machine-readable data into an octree data structure including a plurality of nodes.

13. A machine-readable medium according to claim 11, further comprising instructions which, when executed by a processor, cause the processor to:
instruct an additive manufacturing apparatus to generate a portion of the object based at least in part on the transformed data and the determined property.

14. Apparatus comprising:
a data format modification module to modify a format of data from a first data format into a second data format, the data relating to a three-dimensional object to be generated by an additive manufacturing apparatus, the second data format being suitable for use by the additive manufacturing apparatus to generate the three-dimensional object; and
a retrieval module to retrieve metadata from the data, the metadata relating to a portion of the three-dimensional object.

15. The apparatus of claim 14, wherein the apparatus comprises additive manufacturing apparatus, and further comprises:
a sensor to generate information relating to at least one of: the additive manufacturing apparatus and a portion of the three-dimensional object.
